(19) United States
(12) Patent Application Publication
(10) Pub. No.: US 2023/0169518 A1
(43) Pub. Date: Jun. 1, 2023

(54) Systems and methods for infrastructure asset management, assessment, reporting, planning, and service plans

(71) Applicant: David M. Cornish, Davie, FL (US)

(72) Inventor: David M. Cornish, Davie, FL (US)

(21) Appl. No.: 18/060,541

(22) Filed: Nov. 30, 2022

Related U.S. Application Data
(60) Provisional application No. 63/284,423, filed on Nov. 30, 2021.

(51) Int. Cl. G06Q 30/018

(52) U.S. Cl. CPC G06Q 30/018

(57) ABSTRACT

Systems and methods are provided for infrastructure asset management, assessment, reporting, planning, and service plans. The systems and methods presented comprise equipment, hardware architecture, computer-implemented processes, and instructions configured to carry out the processes. A user may use the systems and methods to facilitate and automate infrastructure asset management, assessment, reporting, planning, and service plans. The present invention solves problems with the currently available systems and methods of asset management, assessment, reporting, planning, and service plans for infrastructure, in particular for water infrastructure.

### FIELD OF THE INVENTION

The present disclosure relates generally to systems and methods for infrastructure asset management, assessment, reporting, planning, and service plans, and in particular to systems and methods for automating the foregoing with regard to infrastructure for water supply, storage, transport, and treatment.

### BACKGROUND OF THE INVENTION

Infrastructure asset management has been a labor-intensive and manual undertaking. To assess infrastructure, generate reports on the conditions and needs of infrastructure, and apply relevant regulations to assess what if anything needs to be repaired, maintained, or upgraded has been a difficult and time-consuming project. To prepare plans for servicing infrastructure, likewise, has been a demanding and manual process. And to conduct and implement the servicing of any plans has been time-consuming and demanding.

### SUMMARY OF THE INVENTION

The present invention meets all these needs, by disclosing systems, and methods, and instructions stored in non-transitory computer-readable media for systems and methods for infrastructure asset management, assessment, reporting, planning, and service plans.

The present invention addresses the problems of the prior art, which do not present systems and methods for automation and facilitation of infrastructure asset management, assessment, reporting, planning, and service plans, in particular with regard to water infrastructure: infrastructure for water supply, storage, transport, and treatment. The present disclosure presents systems and methods for gathering data on infrastructure as a compliance inspection, and for taking the data from the compliance inspection, and using any relevant regulations (including but not limited to OSHA, EPA, any state DEP or other agencies, and others), and information on the condition of structures, to generate a report comprising a maintenance plan, based on the deficiencies in the infrastructure assets, and on the regulations that apply.

The systems and methods disclosed herein comprise gathering data in the field using automated work orders, which may be conducted as part of a compliance inspection. The systems and methods process the foregoing data into a report, with mapping of the gathered data to the regulations. The report can be made available to an agency or an entity that requested it. The systems and methods thereafter produce an asset management recommendation and plan, which may include estimated or quoted costs, for review by the requesting party. And the systems and methods thereafter may allow the requesting party to contract with a party to conduct and carry out the asset management recommendation and plan.

In some aspects, the present disclosure teaches a computer-implemented method for infrastructure asset management, assessment, reporting, planning, and service plans, the method comprising: utilizing a plurality of asset assessment equipment; generating a plurality of customized work orders related to a plurality of infrastructure assets; conducting a compliance inspection using the plurality of customized work orders; gathering a plurality of data and a plurality of metadata from the compliance inspection utilizing the plurality of asset assessment equipment; and compiling the plurality of data and the plurality of metadata into a plurality of automated inspection reports.

In some aspects, the present disclosure teaches a method wherein the plurality of customized work orders are customized based on a plurality of structure-specific data, wherein the plurality of structure-specific data comprise a plurality of data on materials of the infrastructure assets, a plurality of data on types of structures of the infrastructure assets, and a plurality of applicable safety regulations and safety practices.

In some aspects, the present disclosure teaches a method comprising collecting a plurality of regulations, and mapping the plurality of data and the plurality of metadata in the plurality of automated inspection reports onto the plurality of regulations.

In some aspects, the present disclosure teaches a method the plurality of data and the plurality of metadata comprising information on asset attributes; and/or mapping and live mapping of structures; and/or historical records; and/or engineering information.

In some aspects, the present disclosure teaches a method wherein the plurality of asset assessment equipment comprises underwater cameras, underwater vacuums, equipment for centrifugal pumping, and/or equipment for non-destructive testing of infrastructure assets.

In some aspects, the present disclosure teaches a method wherein the equipment for non-destructive testing of infrastructure assets comprises a dry film thickness gauge with underwater probes, and/or ultrasonic thickness gauges, and/or pit-depth micrometers.

In some aspects, the present disclosure teaches a method wherein compiling the plurality of data and the plurality of metadata into a plurality of automated inspection reports further comprises computing a plurality of deficiencies in the plurality of infrastructure asset equipment.

In some aspects, the present disclosure teaches a method the method further comprising generating an asset list, the asset list comprising statuses of infrastructure assets with a plurality of asset characteristics assessed by the plurality of asset assessment equipment.

In some aspects, the present disclosure teaches a method the method further comprising generating an asset management recommendation and plan.

In some aspects, the present disclosure teaches a method the method further comprising allowing a requesting party to trigger a contract with a party to conduct and carry out the asset management recommendation and plan.

In some aspects, the present disclosure teaches a system for infrastructure asset management, assessment, reporting, planning, and service plans, the system comprising a plurality of asset assessment equipment; a plurality of field equipment for managing a plurality of data and a plurality of metadata from a compliance inspection; and a plurality of servers and a plurality of databases for generating a plurality of customized work orders related to a plurality of infrastructure assets.

In some aspects, the present disclosure teaches a system wherein the plurality of asset assessment equipment comprises underwater cameras, underwater vacuums, equipment for centrifugal pumping, and/or equipment for non-destructive testing of infrastructure assets.

In some aspects, the present disclosure teaches a system wherein the equipment for non-destructive testing of infrastructure assets comprises a dry film thickness gauge with underwater probes, and/or ultrasonic thickness gauges, and/or pit-depth micrometers.

In some aspects, the present disclosure teaches a system wherein the plurality of databases contain information on a plurality of structure-specific data, a plurality of regulations, and/or a plurality of automated inspection reports.

In some aspects, the present disclosure teaches a non-transitory computer-readable medium comprising one or more computer-executable instructions that, when executed by at least one processor of a computing device, cause the computing device to execute a method for infrastructure asset management, assessment, reporting, planning, and service plans.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter. The terms “approximate” or “approximately” and similar conjugates mean, for purposes of this disclosure, values within 10% of each other or within 10% of a specified value or end-values of a range of values. The singular and plural are interchangeable and a term in the singular includes the plural, or vice-versa, unless such reading is contradicted by the context. Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components, or steps of the methods, throughout the different figures. In the following detailed description, various aspects of the present invention are described with reference to the following drawings, in which:

FIG. 1 illustrates a schematic view of a method of the present disclosure.

FIG. 2 illustrates a schematic view of a system of the present disclosure, showing an environment in which the disclosure is utilized.

FIG. 3 illustrates a schematic view of a system of the present disclosure, showing an environment in which the disclosure is utilized.

### DETAILED DESCRIPTION OF THE DRAWINGS

The presently disclosed invention is described with specificity to meet statutory requirements. But, the description itself is not intended to limit the scope of this patent. Rather, the claimed invention might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of use of the present invention.

In one aspect, the present disclosure presents a system and methods for infrastructure asset management, with automated assessment, reporting, planning, and service plans. The methods disclosed herein may be computer-implemented methods, and computer-executable instructions for the computer-implemented methods may be stored in a non-transitory computer-readable medium.

The present invention comprises a system and methods for infrastructure asset management, assessment, reporting, planning, and service plans. The present disclosure presents systems and methods for gathering data on infrastructure as a compliance inspection, and for taking the data from the compliance inspection, and using any relevant regulations (including but not limited to OSHA, EPA, any state DEP or other agencies, and others), and information on the condition of structures, to generate a report comprising a maintenance plan, based on the deficiencies in the infrastructure assets, and on the regulations that apply.

The systems and methods disclosed herein comprise gathering data in the field using automated work orders, which may be conducted as part of a compliance inspection. The systems and methods process the foregoing data into a report, with mapping of the gathered data to the regulations. The report can be made available to an agency or an entity that requested it. The systems and methods thereafter produce an asset management recommendation and plan, which may include estimated or quoted costs, for review by the requesting party. And the systems and methods thereafter may allow the requesting party to contract with a party to conduct and carry out the asset management.

The present disclosure presents systems and methods for automated water infrastructure asset management and tank maintenance. A compliance inspection is performed using customized work orders to gather nearly a plurality of data and metadata, and this data and metadata is compiled into a plurality of automated inspection reports. The inspection reports can be viewed through the system and methods, where all data and metadata, including but not limited to asset attributes, live mapping of structures, historical records, and engineering documents can be viewed and managed by a plurality of users.

The system and methods present a plurality of recommendations for upgrades and/or repairs, including but not limited to costs, and may be assessed for priority and mapped out based on the priority of these deficiencies. The products and/or services outlined in the recommendations can be planned for service by the provider of the disclosed systems and methods. The systems and methods may generate a plurality of proposals for work, and the plurality of proposals will be available directly on a platform as part of the systems and methods. The platform will allow access by the plurality of users during meetings and for budgeting and planning as a visual tool.

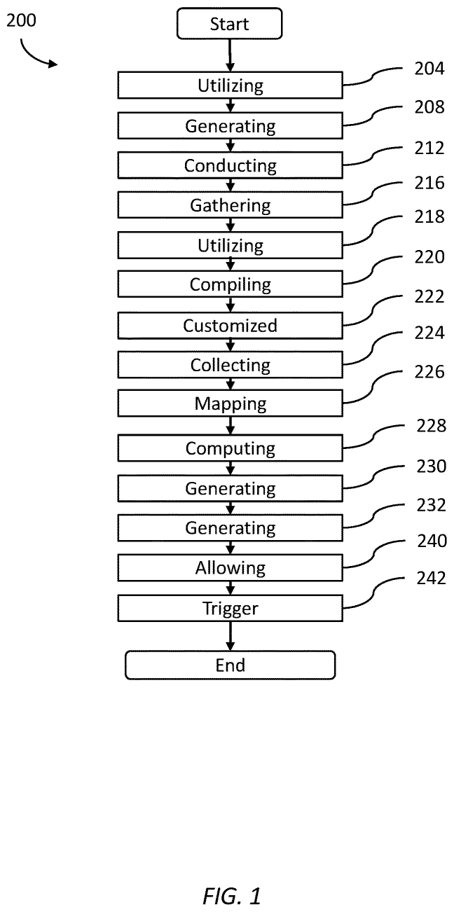

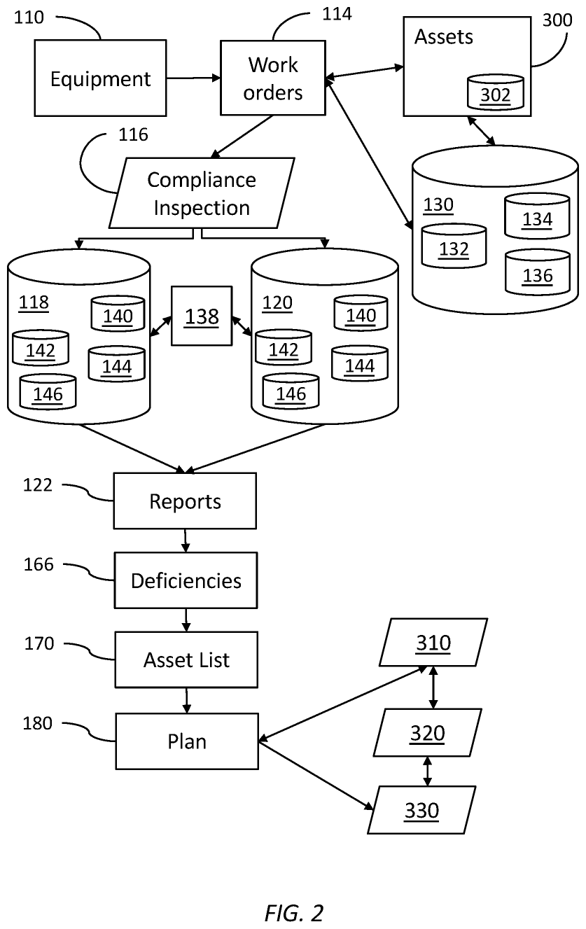

FIGS. 1-3 present views of the methods, systems, and workflow of the present disclosure. With reference to FIG. 1 and FIG. 2, the present disclosure teaches a method 200, implemented on a computer and equipment as described herein, for infrastructure asset management, assessment, reporting, planning, and service plans. The method 200 comprises utilizing 204 a plurality of asset assessment equipment 110; generating 208 a plurality of customized work orders 114 related to a plurality of infrastructure assets 300. The plurality of customized work orders 114 are structure-specific, meaning specific to the infrastructure assets 300. The method 200 comprises conducting 212 a compliance inspection 116 using the plurality of customized work orders 114; and gathering 216 a plurality of data 118 and a plurality of metadata 120 from the compliance inspection 116, utilizing 218 the plurality of asset assessment equipment 110. The method 200 further comprises compiling 220 the plurality of data 118 and the plurality of metadata 120 into a plurality of automated inspection reports 122.

In some aspects of the present disclosure, the plurality of customized work orders 114 are customized 222 based at least in part on a plurality of structure-specific data 130, wherein the plurality of structure-specific data 130 may comprise a plurality of data on materials 132 of the infrastructure assets, a plurality of data on types of structures 134 of the infrastructure assets, and/or a plurality of applicable safety regulations and safety practices 136.

In some aspects of the present disclosure, the method 200 further comprises collecting 224 a plurality of regulations 138, and mapping 226 the plurality of data 118 and the plurality of metadata 120 in the plurality of automated inspection reports 122 onto the plurality of regulations 138. The plurality of data 118 and the plurality of metadata 120 may comprise information on asset attributes 140; and/or mapping and live mapping 142 of structures; and/or historical records 144; and/or engineering information 146.

The plurality of asset assessment equipment 110 may comprise underwater cameras 150, underwater vacuums 152, equipment for centrifugal pumping 154, and/or equipment for non-destructive testing 156 of infrastructure assets. The equipment for non-destructive testing 156 of infrastructure assets may comprise a dry film thickness gauge with underwater probes 158, and/or ultrasonic thickness gauges 160, and/or pit-depth micrometers 162.

In some aspects of the present disclosure, compiling 220 the plurality of data 118 and the plurality of metadata 120 into a plurality of automated inspection reports 122 comprises computing 228 a plurality of deficiencies 166 in the plurality of infrastructure assets 300. The method 200 may further comprise generating 230 an asset list 170, the asset list 170 comprising statuses of the plurality of infrastructure assets 300 with a plurality of asset characteristics 302 assessed by the plurality of asset assessment equipment 110. The method 200 may further comprise generating 232 an asset management recommendation and plan 180. In some aspects of the present disclosure, the method 200 may comprise allowing 240 a requesting party 310 to trigger 242 a contract 320 with a providing party 330 to conduct and carry out the asset management recommendation and plan 180.

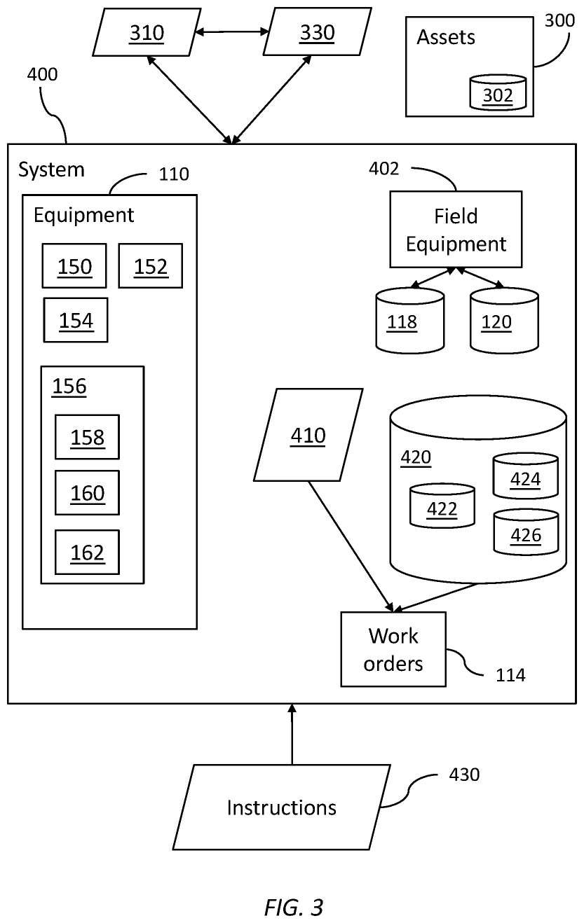

With reference to FIG. 2 and FIG. 3, the present disclosure teaches a system 400 for infrastructure asset management, assessment, reporting, planning, and service plans, the system comprising a plurality of asset assessment equipment 110; a plurality of field equipment 402 for managing the plurality of data 118 and the plurality of metadata 120 from a compliance inspection 116; and a plurality of servers 410 and a plurality of databases 420 for generating a plurality of customized work orders 114 related to the plurality of infrastructure assets 300. The plurality of asset assessment equipment 110 may comprise underwater cameras 150, underwater vacuums 152, equipment for centrifugal pumping 154, and/or equipment for non-destructive testing 156 of infrastructure assets 300. The equipment for non-destructive testing 156 of infrastructure assets 300 may comprise a dry film thickness gauge with underwater probes 158, and/or ultrasonic thickness gauges 160, and/or pit-depth micrometers 162.

The plurality of databases 420 may contain information on a plurality of structure-specific data 422, a plurality of regulations 424, and/or a plurality of automated inspection reports 426.

The present disclosure may comprise a non-transitory computer-readable medium comprising one or more computer-executable instructions 430 that, when executed by at least one processor of a computing device, cause the computing device to execute a method for infrastructure asset management, assessment, reporting, planning, and service plans, as described herein.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device, also referred to as a processor, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Herein, reference to a computer-readable storage medium encompasses one or more non-transitory, tangible computer-readable storage-media possessing structure or structures. As an example and not by way of limitation, a computer-readable storage medium may include a semiconductor-based medium or other integrated circuit (IC), including but not limited to a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101.

The present disclosure encompasses all changes, substitutions, variations, alterations, and modifications to the example embodiments herein that a person having ordinary skill in the art would comprehend. Likewise, the appended claims encompass, where appropriate, all changes, substitutions, variations, alterations, and modifications to the example embodiments herein that a person having ordinary skill in the art would comprehend.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of automated systems and processes for water infrastructure asset management, it will be apparent to one of ordinary skill in the art that the invention may be used with any infrastructure asset management. The invention is thus not limited to any particular type of communication system, network, protocol, format, or application.

Some portions of this description describe the embodiments of the invention in terms of algorithms and symbolic representations of operations on information. These algorithmic descriptions and representations are commonly used by those skilled in the infrastructure management arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, other code or location for code, or any combinations thereof.

Any of the steps, operations, or processes described herein may be performed or implemented with one or more hardware or software modules, alone or in combination with other devices.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The non-transitory computer-readable medium may comprise one or more computer-executable instructions that, when executed by at least one processor of a computing device, cause the computing device to execute a method for infrastructure asset management, assessment, reporting, planning, and service plans, as described above

While the foregoing processes and mechanisms can be implemented by a wide variety of physical systems and in a wide variety of network and computing environments, the server or computing systems described below provide example computing system architectures for didactic, rather than limiting, purposes.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Certain aspects of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A computer-implemented method for infrastructure asset management, assessment, reporting, planning, and service plans, the method comprising:
utilizing a plurality of asset assessment equipment;
generating a plurality of customized work orders related to a plurality of infrastructure assets;
conducting a compliance inspection using the plurality of customized work orders;
gathering a plurality of data and a plurality of metadata from the compliance inspection utilizing the plurality of asset assessment equipment; and
compiling the plurality of data and the plurality of metadata into a plurality of automated inspection reports.

2. The method of claim 1, wherein the plurality of customized work orders are customized based on a plurality of structure-specific data, wherein the plurality of structure-specific data comprise a plurality of data on materials of the infrastructure assets, a plurality of data on types of structures of the infrastructure assets, and a plurality of applicable safety regulations and safety practices.

3. The method of claim 1, the method further comprising collecting a plurality of regulations, and mapping the plurality of data and the plurality of metadata in the plurality of automated inspection reports onto the plurality of regulations.

4. The method of claim 1, the plurality of data and the plurality of metadata comprising information on asset attributes; and/or mapping and live mapping of structures; and/or historical records; and/or engineering information.

5. The method of claim 1, wherein the plurality of asset assessment equipment comprises underwater cameras, underwater vacuums, equipment for centrifugal pumping, and/or equipment for non-destructive testing of infrastructure assets.

6. The method of claim 5, wherein the equipment for non-destructive testing of infrastructure assets comprises a dry film thickness gauge with underwater probes, and/or ultrasonic thickness gauges, and/or pit-depth micrometers.

7. The method of claim 1, wherein compiling the plurality of data and the plurality of metadata into a plurality of automated inspection reports further comprises computing a plurality of deficiencies in the plurality of infrastructure asset equipment.

8. The method of claim 1, the method further comprising generating an asset list, the asset list comprising statuses of infrastructure assets with a plurality of asset characteristics assessed by the plurality of asset assessment equipment.

9. The method of claim 1, the method further comprising generating an asset management recommendation and plan.

10. The method of claim 9, the method further comprising allowing a requesting party to trigger a contract with a party to conduct and carry out the asset management recommendation and plan.

11. A system for infrastructure asset management, assessment, reporting, planning, and service plans, the system comprising a plurality of asset assessment equipment; a plurality of field equipment for managing a plurality of data and a plurality of metadata from a compliance inspection; and a plurality of servers and a plurality of databases for generating a plurality of customized work orders related to a plurality of infrastructure assets.

12. The system of claim 11, wherein the plurality of asset assessment equipment comprises underwater cameras, underwater vacuums, equipment for centrifugal pumping, and/or equipment for non-destructive testing of infrastructure assets.

13. The system of claim 12, wherein the equipment for non-destructive testing of infrastructure assets comprises a dry film thickness gauge with underwater probes, and/or ultrasonic thickness gauges, and/or pit-depth micrometers.

14. The system of claim 11, wherein the plurality of databases contain information on a plurality of structure-specific data, a plurality of regulations, and/or a plurality of automated inspection reports.

15. A non-transitory computer-readable medium comprising one or more computer-executable instructions that, when executed by at least one processor of a computing device, cause the computing device to execute a method for infrastructure asset management, assessment, reporting, planning, and service plans.
